(19) United States
(12) Patent Application Publication
(10) Pub. No.: US 2015/0291087 A1
(43) Pub. Date: Oct. 15, 2015

(54) ILLUMINATED CAR NAMEPLATE

(71) Applicant: Aleksandr Alekseevich Zharov, Moscow (RU)

(72) Inventor: Aleksandr Alekseevich Zharov, Moscow (RU)

(21) Appl. No.: 14/404,668

(22) PCT Filed: Jan. 17, 2013
(86) PCT No.: PCT/RU2013/000033

§ 371 Date: Dec. 1, 2014

(30) Foreign Application Priority Data
May 29, 2012 (RU) 2012121939

(51) Int. Cl. B60Q 1/56

(52) U.S. Cl. CPC B60Q 1/56

(57) ABSTRACT

The invention relates to decorative elements for a car. The backlit car nameplate comprises a basic element, a first translucent element and a light source. The basic element is formed from non-translucent material. An aperture is formed on the upper surface side of the basic element. The first translucent element is arranged in the aperture of the basic element. The light source makes it possible for light radiation to pass from the light source through the first translucent element. According to the first alternative, a connecting surface of the basic element provides for the fixing of the device to a car body. According to the second alternative, the nameplate comprises a second translucent element. The connecting surface of the basic element is connected to the connecting surface of the second translucent element. The connecting surface of the second translucent element makes it possible to fix the device to the car body. The light source makes it possible for light radiation to pass through the first translucent element and through the second translucent element. An increase in luminosity is achieved.

### CROSS-REFERENCE TO RELATED APPLICATIONS

The current application claims priority to PCT application No. PCT/RU2013/000033 filed on Jan. 17, 2013, which claims priority to Russian application No. RU 2012121939 filed on May, 29 2012.

### FIELD OF INVENTION

The utility model relates to decorative elements for cars.

### PRIOR ART

An illuminated nameplate for HONDA cars is well known and disclosed, for example, on the webpage: DRIVE2.RU. Community of cars and people. LED tuning: Blog. Illuminated nameplate HONDA. URL: http ://www.drive2 .ru/communities/ledtuning/blog/288230376151805419/ (application date 22.03.2012). The illuminated nameplate consists of an opaque translucentnameplate, a diode strip, translucenttranslucent insert and fastening means. The nameplate has a recess which houses the diode strip. On the diode strip side, the nameplate is connected to the translucenttranslucent insert. On the opposite side from the connection with the nameplate, the translucenttranslucent insert is provided with fastening means. The fastening means serve to connect the illuminated nameplate to the surface of the vehicle.

One shortcoming of this solution is its low light efficiency.

Another technical solution (prototype) is illuminated nameplate of RU patent No. 114296, priority date 13 Dec. 2011, publication date 20 March 2012. The illuminated vehicle nameplate contains a main element with opposite locations of the outer surface and the first inner surface, a translucent element with opposite locations of the second inner surface and the connecting surface, and a light source. The main element is made of opaque material.

The first inner of the main element surface are connected with the second inner surface of the translucent element. The light source is made in the form of a light-emitting diode strip and located between the main element and the connecting surface. A groove is made in the translucent element on the side of the second inner surface. The light source is located in the given channel. The device is fixed to the vehicle body by a connecting surface. The light source is connected to the power supply. The illumination from the light source passes through the translucent element and illuminates the perimeter of the nameplate.

One shortcoming of the prototype is its low light efficiency.

The purpose of the proposed invention is to increase the light efficiency.

### SUMMARY

The set goal is achieved by the first embodiment of the illuminated vehicle nameplate having a main element with opposite locations of the second outer surface and the second inner surface and the outer surface and the first connecting surface being located between the second inner surface and the second outer surface with the opposite side of the main element, a first translucent element with side surfaces, as well as a first inner surface and first outer surface located on opposite sides of the first translucent element, and a light source. The main element is made of opaque material, being connected with the first translucent element and having an aperture on the side of the outer surface; the first translucent element is located in the main element aperture; the main element is connected to the first translucent element through connection of the second inner surface to the side surface; the first connecting surface is made to provide for the device to be secured to the vehicle body; the light source is located on the side of the first translucent element facing the first connecting surface, allowing for the light to pass from the light source through the first translucent element; by the second variant of the illuminated vehicle nameplate having a main element with a second outer surface and a second inner surface located on opposite sides of the main element, and a upper surface and a first connecting surface located between the second inner surface and the second outer surface on opposite sides of the main element, a second translucent element with a third inner surface and third outer surface located on opposite sides of the second translucent element, and a second connecting surface and a third connecting surface located between the third inner surface and third outer surface on opposite sides of the second translucent element, a light source, and a main element made of opaque material. The main element of the first connecting surface is connected with the second connecting surface of the second translucent element, having an aperture on the side of the upper surface; in addition, a third connecting surface is made to provide for the device to be secured to the vehicle body, distinguished by also including a first translucent element with side surfaces, as well as the first inner surface and the first outer surface being located on opposite sides of the first translucent element; the first translucent element is located in the aperture of the main element; the main element is connected by the second inner surface to the side surface of the first translucent element; the light source is located on the side of the first connecting surface allowing for the light to pass through the first translucent element and the second translucent element.

### BRIEF DESCRIPTION OF DRAWINGS

FIG. 1 shows the first embodiment of the illuminated nameplate.

FIG. 2 shows the second embodiment of the illuminated nameplate.

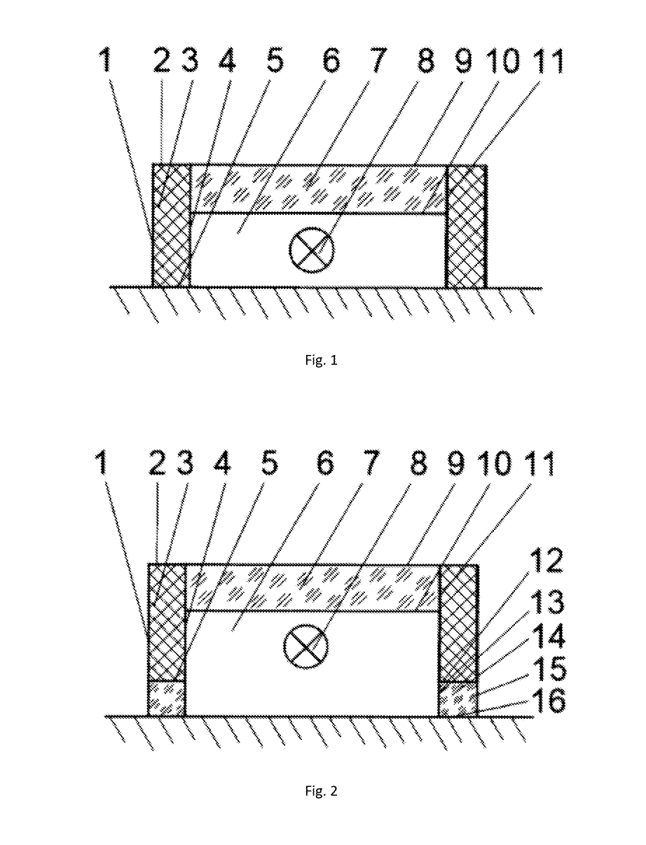

### DETAILED DESCRIPTION OF THE PREFERRED EMBODIMENTS

The elements in the figures are the following: a second outer surface 1, an upper surface 2, a main element 3, a second inner surface 4, a first connecting surface 5, a recess 6, a first translucent element 7, a light source 8, a first outer surface 9, a first inner surface 10, a side surface 11, a second connecting surface 12, a third inner surface 13, a second translucent element 14, a third outer surface 15, and a third connecting surface 16.

The main elements of the first version of the device are the main element 3, the first translucent element 7, the light source 8 and the means of fastening.

The nameplate constitutes a decorative element that may reproduce the form of any letter or figure or a contour of any figure. The nameplate consists of the main element 3, the first translucent element 7 and the light source 9.

The main element 3 constitutes a closed opaque element, i.e., an element in the form of a closed contour not letting light in the visible spectre through. The main element 3 is made of any firm material, such as any plastic or metal. The main element 3 is supplied with the second outer surface 1, the second inner surface 4, the upper surface 2 and the first connecting surface 5. At the same time, the second outer surface 1 and the second inner surface 4 are located opposite to each other, i.e., on opposite sides of the main element 3 in relation to each other. The upper surface 2 and the first connecting surface 5 are located opposite each other, i.e., on opposite sides of the main element 3 in relation to each other.

The main element 3 may be made in any complex form, including rounded in the form of a hemisphere or any other integral form. At the same time, the second outer surface 1 and the upper surface merge smoothly into each other without forming any dividing line. In this case, the division between the surfaces of the main element 3 is made arbitrarily. At the same time, the second outer surface 1 is located close to the first connecting surface 5, i.e., is adjacent to it. The upper surface 2 is located on the side of the first translucent element 7, mostly facing in the opposite direction from the first connecting surface 5. At the same time, an aperture is made in the main element 3 on the side of the upper surface. In certain cases, the aperture is made right through on the side of the upper surface 2 to the first connecting surface 5. The aperture is formed by the second inner surface 4 of main element 3. The second inner surface 4 may be made in any form, including steps or any other. In certain cases, the aperture may be made in the form of the first translucent element 7. The main element 3 is located along the perimeter of the first translucent element 7. The second outer surface 1 faces outwards, in the opposite direction from the first translucent element 7. The second inner surface 4 is turned towards the first translucent element 7 and the recess 6 including light source 8. At the same time, the term “faces in the direction of” means the location of the second inner surface 4 from the same side as the first translucent element 7 in relation to the main element 3. The upper surface 2 is turned outwards and is located on the side of the first outer surface 9 of the first translucent element 7. The first connecting surface 5 is made to provide for the device to be connected to the vehicle body, such as by means of a fastening.

The first translucent element 7 is made flat to provide for placement of the first translucent element 7 in the aperture of main element 3 and its attachment at least partially to the second inner surface 4, and also allowing for formation in the device of the recess 6 on the side of the first connecting surface 5 after attachment of the first translucent element 7 to the main element 3. In certain cases, the first translucent element 7 is made in the form of a figure formed of the second inner surface 4 of the main element 3. The first translucent element 7 is supplied with the first inner surface 10, the first outer surface 9, and the side surfaces 11. At the same time, the first outer surface 9 and the first inner surface 10 are located opposite to each other. The side surfaces 11 constitute the surface of the first translucent element 7, facing the main element 3. At the same time, the side surfaces 11 of the first translucent element 7 are understood as parts of the integral side surface 11, arbitrarily divided into these parts. The distance between the first inner surface 10 and the first outer surface 9 is made several times less than the sizes of the first inner surface 10 and the first outer surface 9. The first translucent element 7, in certain cases its the first inner surface 10 and the first outer surface 9, may be made integral, or consisting of several parts. The first translucent element 7 faces the recess 6 of the first inner surface 10. The first outer surface 9 of the first translucent element 7 faces outwards, i.e., in the direction from the recess 6 with the light source 8. The first translucent element 7 is made of translucent material, i.e., of material that lets light through, such as glass, or translucent plastic, including matt plastic that diffuses the light passing through it. The first translucent element 7 is connected by the side surfaces 11 to the second inner surface 4 of the main element 3 close to the upper surface 2. At the same time, between the first inner surface 10 and the second inner surface 4, which is made closed, the recess 6 is formed.

The recess 6 constitutes a cavity in any form, created on the side of first connecting the surface 5 of the first inner surface 10 and the second inner surface 4, after placement of the first translucent element 7 in the aperture of the main element 3 and attachment of the first translucent element 7 and the main element 3. The recess 6 is made allowing for placement therein of the light source 8. The recess 6 may be made in any form.

The fastening is made to provide for connection of the device to the body of the vehicle. The fastening may consist of an adhesive substance applied to first connecting the surface 5 or any other fixative applicable in the given sphere.

The light source 8 constitutes any source of light applicable in the given sphere, such as a light-emitting diode or several light-emitting diodes, or a strip of light-emitting diodes, or a flexible rod made to provide bright even light throughout its length, such as an electroluminescent wire. The light source 8 is placed in the recess 6.

The main elements of the second version of the device comprises: the main element 3, the first translucent element 7, the light source 8, the second translucent element 14 and the fastening.

The nameplate constitutes a decorative element that may reproduce the form of any letter or figure or the contour of any figure. The nameplate consists of the main element 3, the first translucent element 7, the second translucent element 14 and the light source 8.

The main element 3 constitutes a closed opaque element, i.e., the element in the form of a closed contour not letting through visible spectre light. The main element 3 is made of any firm material, such as any plastic or metal. The main element 3 is supplied with the second outer surface 1, the second inner surface 4, the upper surface 2 and the first connecting surface 5. At the same time, the second outer surface 1 and the second inner surface 4 are located opposite to each other, i.e., on opposite sides of the main element 3 in relation to each other. The upper surface 2 and the first connecting surface 5 are located opposite to each other, i.e., on opposite sides of the main element 3 in relation to each other. The main element 3 may be made in any complex form, including rounded in the form of a hemisphere or any other rounded form. At the same time, the second outer surface 1 and the upper surface merge smoothly into each other without forming any dividing line. In this case, the division between the surfaces of the main element 3 is made arbitrarily. At the same time, the second outer surface 1 is located close to the first connecting surface 5, i.e., is adjacent to it. The upper surface 2 is located on the side of the first translucent element 7, mostly facing in the opposite direction from the first connecting surface 5. At the same time, in the main element 3 on the side of the upper surface 2 an aperture is made, in certain cases right through from the upper surface 2 to the first connecting surface 5. The second inner surface 4 may be made in any form, including stepped or any other. In certain cases, the aperture may be made in the form of the first translucent element 7. The main element 3 is located along the perimeter of the first translucent element 7. The second outer surface 1 faces outwards, in the opposite direction from the first translucent element 7. The second inner surface 4 faces towards the first translucent element 7 and the recess 6 including the light source 8. At the same time, the term “faces in the direction of” means the location of the second inner surface 4 from the same side as the first translucent element 7 in relation to the main element 3. The upper surface 2 faces outwards and is located on the side of the first outer surface 9 of the first translucent element 7. The first connecting surface 5 is made to provide for connection to the translucent element 14, such as by means of an adhesive substance.

The first translucent element 7 is made flat, to provide for placement of the first translucent element 7 in the aperture of the main element 3 and its connection at least partially to the second inner surface 4, and also allowing for formation in the device of the recess 6 on the side of the first connecting surface 5 after attachment of the first translucent element 7 with the main element 3. In certain cases, the first translucent element 7 is made in the form of a figure formed of the second inner surface 4 of the main element 3. The first translucent element 7 is supplied with the first inner surface 10, the first outer surface 9, and the side surfaces 11. The side surfaces 11 of the first translucent element 7 are understood as part of integral the side surface 11, arbitrarily divided into these parts. At the same time, the first outer surface 9 and the first inner surface 10 are located opposite each other. The distance between the first inner surface 10 and the first outer surface 9 is made several times less than the sizes of the first inner surface 10 and the first outer surface 9. The first translucent element 7, in certain cases its first inner surface 10 and the first outer surface 9, may be made integral, or consisting of several parts. The first translucent element 7 faces the recess 6 of the first inner surface 10. The first outer surface 9 of the first translucent element 7 is turned outwards, i.e., in the direction from the recess 6 with the light source 8. The first translucent element 7 is made of translucent material, i.e., of material that lets light through, such as glass, or translucent plastic, including matt plastic that diffuses the light passing through it. The first translucent element 7 is connected by the side surfaces 11 to the second inner surface 4 of the main element 3 close to the upper surface 2. At the same time, between the first inner surface 10 and the second inner surface 4, which is made closed, the recess 6 is formed.

The recess 6 constitutes a cavity in any form, created on the side of the first connecting surface 5 of the first inner surface 10 and of the second inner surface 4, after placement of the first translucent element 7 in the aperture of main element 3 and attachment of the first translucent element 7 and the main element 3. The recess 6 is made to provide for placement therein of the light source 8. The recess 6 may be made in any form.

The light source 8 constitutes any source of light applicable in the given sphere, such as a light-emitting diode or several light-emitting diodes, or a strip of light-emitting diodes, or a flexible rod made to provide bright even light throughout its length, such as an electroluminescent wire. The light source 8 is placed in the recess 6.

The second translucent element 14 is made flat, in the form of a figure similar to the main element 3 on the side of the first connecting surface 5. The second translucent element 14 is supplied with the third inner surface 13, the third outer surface 15, the second connecting surface 12 and the third connecting surface 16. The third outer surface 15 and the third inner surface 13 are located opposite to each other. The second connecting surface 12 and the third connecting surface 16 are located opposite to each other. The third inner surface 13 faces the recess 6 with the light source 8 and is made as an extension of the second inner surface 4 of the main element 3. The third outer surface 15 is turned outwards, i.e., in the direction from the light source 8 and is made as an extension of the second outer surface 1 of the main element 3. The form of the second connecting surface 12 is made to replicate the form of the first connecting surface 5 of the main element 3. The second translucent element 14 is connected along the second connecting surface 12 with the first connecting surface 5. The third connecting surface 16 is made to provide for connection of the device to the vehicle body, such as by means of a fastening. The second translucent element 14 is made of translucent material, i.e., of a material that lets light through.

The fastening is made to provide for connection of the device to the body of the vehicle. The fastening may consist of an adhesive substance applied to third connecting surface 16 or any other applicable fixative.

### INDUSTRIAL APPLICABILITY

The first version of the utility model is realised as follows. The main element 3 is made with the second outer surface 1, the second inner surface 4, the upper surface 2 and the first connecting surface 5. The first translucent element 7 is made with the first inner surface 10, the first outer surface 9 and the side surfaces 11. The light source 8 and also, if necessary, the fastening are made. The first translucent element 7 is connected by the side surfaces 11 to the second inner surface 4 of the main element 3 close to the upper surface 2 of the main element 3, such as by means of an adhesive substance or other fixative applicable in the given sphere.

At the same time, between the second inner surface 4 of the main element 3 and the first inner surface 10 of the first translucent element 7, the recess 6 is formed. The light source 8 is placed in the recess 6. The first connecting surface 5 of the device is connected to the vehicle body by means of a fastening. The wires from the light source 8 are connected to the vehicle's dashboard power supply. The first outer surface 9 is turned away from the vehicle body. When the dashboard power supply is switched on, the light source 8 lights up. The light emitted by the light source 8 does not pass through the material of the main element 3, which is opaque, i.e., the light is absorbed thereby. The emitted light passes through the first translucent element 7. Whereat the emitted light may be of any color. The light source 8 may be of a single or several colors and the first translucent element 7 colorless or by making the light source 8 colorless and the first translucent element 7 of any hue.

The second version of the utility model is realised as follows. The main element 3 is made with the second outer surface 1, the second inner surface 4, the upper surface 2 and the first connecting surface 5. The first translucent element 7 is made with the first inner surface 10, the first outer surface 9 and the side surfaces 11. The second translucent element 14 is made with the third inner surface 13, the third outer surface 15, the second connecting surface 12 and the third connecting surface 16. The light source 8 and also, if necessary, the fastening are made. The first translucent element 7 is connected by the side surfaces 11 to the second inner surface 4 of the main element 3 close to the upper surface 2 of the main element 3, such as by means of an adhesive substance or other applicable fixative . The second connecting surface 12 of the second translucent element 14 is connected to the first connecting surface 5 of the main element 3, such as by means of an adhesive substance or other applicable fixative. At the same time, between the second inner surface 4 of the main element 3, the third inner surface 13 of the second translucent element 14 and the first inner surface 10 of first translucent element 7, the recess 6 is formed. The light source 8 is placed in the recess 6. The third connecting surface 16 of the device is connected to the vehicle body by means of a fastening.

The wires from the light source 8 are connected to the vehicle's dashboard power supply. The first outer surface 9 is turned away from the vehicle body. When the dashboard power supply is switched on, the light source 8 lights up. The light emitted by the light source 8 does not pass through the material of the main element 3, which is opaque, i.e., the light is absorbed thereby. The emitted light passes through the first translucent element 7 and the second translucent element 14. Whereat the emitted light may be of any color. The light source 8 may be of a single or several colors and the first translucent element 7 and the second translucent element 14 colorless or by making light source 8 colorless and the first translucent element 7 and the second translucent element 14 of any hue.

The given technical solution allows an additional artistic result to be achieved by giving the first translucent element the form of any figure, the contour of any figure, letter, set of letters or a whole word.

The fact that the device is made up of an opaque main element, a first translucent element and second translucent element and a light source thus ensures higher light efficiency through introduction into the device of the first translucent element.

1. An illuminated vehicle nameplate, comprising: a main element with a second outer surface and a second inner surface located on opposite sides of the main element, and also with an upper surface and a first connecting surface located between the second inner surface and the second outer surface on opposite sides of the main element, a first translucent element with side surfaces, and also a first inner surface and a first outer surface located on opposite sides of the first translucent element, and a light source, the main element being made of opaque material and connected to the first translucent element; an aperture is made in the main element on a side of the upper surface, distinguished by the first translucent element being located in the aperture of the main element; the main element is connected to the first translucent element through connection of the second inner surface to the side surface; the first connecting surface is made to provide an attachment of the nameplate to the vehicle body; the light source is located on a side of the first translucent element, facing the first connecting surface, allowing for light to pass from the light source through the first translucent element.

2. An illuminated vehicle nameplate, comprising: a main element with a second outer surface and second inner surface located on opposite sides of the main element, and an upper surface and a first connecting surface located between the second inner surface and the second outer surface on opposite sides of the main element, a second translucent element with a third inner surface and a third outer surface located on opposite sides of the second translucent element, and a second connecting surface and a third connecting surface located between the third inner surface and the third outer surface on opposite sides of the second translucent element; a light source; the main element is made of opaque material, the main element's first connecting surface being connected with the second connecting surface of the second translucent element; an aperture is made in the main element on a side of the upper surface, and the third connecting surface is made to provide for the nameplate to be secured to the vehicle body, also including a first translucent element with side surfaces and a first inner surface and a first outer surface located on opposite sides of the first translucent element; the first translucent element is located in an aperture of the main element; the second inner surface of the main element is connected to the side surface of the first translucent element; the light source is located on the side of the first connecting surface allowing for the light to pass through the first translucent element and the second translucent element.
